(19) United States
(12) Patent Application Publication
(10) Pub. No.: US 2007/0031112 A1
(43) Pub. Date: Feb. 8, 2007

(54) Fast generation of a personalized DVD from a common template

(75) Inventor: Arnaud Ricci, Saint-Cezaire-sur-Siagne (FR)

Correspondence Address: ZITO TLP, 26005 RIDGE ROAD, SUITE 203, DAMASCUS, MD, 20872, US

(73) Assignee: Triverity Corporation

(21) Appl. No.: 11/199,543

(22) Filed: Aug. 8, 2005

(51) Int. Cl. H04N 7/00

(52) U.S. Cl. 386/95

(57) ABSTRACT

The invention prepares real-time audio and video contents for generating a personalized multimedia data structure and content from a pre-authored data structure and content. The invention can produce a DVD-compatible template folder with a placeholder video file as an input of the process. The template folder is modified with insertion of a new video file collected from a live event that replaces the placeholder file. A final personalized multimedia optical medium is generated after revising the template folder with new menu and title information.

### FIELD OF THE INVENTION

The present invention relates to a method and apparatus for formatting and recording audio, video, and/or statistical data onto a multimedia recording medium, such as a Digital Versatile Disk (DVD).

### BACKGROUND OF THE INVENTION

The format and file structure of a commercial DVD is currently governed by compliance standards produced by governing bodies such as the Format/Logo Licensing Corporation (FLLC). The DVD Consortium was formed in 1995 to standardize the emerging technology of using lasers to record and play back quality video from an optical disk. Commercially available DVD discs can contain 4.7 gigabytes or more of recorded data. The DVD specification uses a file system to retain information about the data content on the disk. This file system is found within the data. The information is called the lead-in and contains control data that describes the disk's size, transfer rates, track density, the linear recording density, starting and ending sector numbers, and whether the disc is a read-only DVD or whether the disk can be written to many times similar to a traditional hard disk.

DVD cutting is performed by cutting device using a Laser Beam Recorder (LBR) that produces the end-product DVD. A laser is used by the cutting device to burn tiny microscopic pits that represent 1's and 0's of bits of data into the substrate of the optical medium. A different laser then can read the pits as the disc turns and reproduce the data bits that were recorded thereon. In order to increase the capacity of the original DVDs, dual-layer discs are used that burn the pits into different levels of the medium substrate.

DVDs that are recorded onto one and then closed from further recording are called DVD-Read-Only Memory (ROM) discs. These discs are typically used in the video and audio recording industries to record movies and song collections for playback by end users. Motion picture files, audio files, still pictures called “sub-picture data”, and data files can all be integrated into a DVD. For motion pictures the DVD incorporates the standard file format for video data compression using a variable bit rate from the Motion Pictures Experts Group (MPEG). The DVD standards incorporate three different types of audio formats: linear Pulse Code Modulation (PCM), Dolby Digital (Trademark of the Dolby Laboratories Licensing Corporation), and MPEG audio. To create the formatted DVD, The MPEG video file is multiplexed with audio content and still pictures into a formatted data architecture that includes system information that is then recorded onto the optical disc. The MPEG encoding standard uses a timing feature to synchronize the audio and video. The standard uses a system clock reference (SCR) for the MPEG-specified “system clock” that runs at 90 KHz. The MPEG standard also places a presentation time stamp (PTS) into the MPEG bitstream. The system clock references and the presentation time stamps are encoded into the MPEG bitstream. PTS are samples from the encoder system clock for the video and audio bitstream that synchronizes the time to play the audio with the correct video picture.

A DVD can store enough digital data to hold an entire motion picture in high quality format and typically additional videos or data up to the maximum capacity of the disc. The video is divided into chapters. A unique feature of the DVD is the ability to jump to different chapters of a video or multiple videos through user selection from a main menu page and using menu buttons on a remote control device to a DVD player. This feature is afforded by the standard structure of the files and data on the disc.

Inherent drawbacks to the advantageous large data capacity and standardized format structure of the file system is the length of recording time that is required by a cutting device to produce a DVD playable in commercially-available DVD players and the inability to personalize the DVD file format. Current DVD authoring methods require the availability of all DVD assets (e.g., the video, audio, pictures, and menus) at the beginning of the authoring process. To generate the final DVD, authoring tools require the execution of scripts that in turn create the DVD compliant files. Further, Recording time for an entire DVD can take fifteen minutes or more per disc, and the rigid structure of the standard DVD-ROM format requires for the entire file to be recorded onto an optical disk in a single session.

A DVD is typically designed for mass-production of a fixed video content. To personalize the format of individual DVDs with unique audio/video content, current methods require a complete re-authoring of the entire DVD content.

### SUMMARY OF THE INVENTION

To overcome disadvantages of DVD authoring and generation that are typically designed for mass-production of a fixed video content, the present invention provides a method and apparatus to generate a template for merging one or more audio/visual recordings into a pre-authored data structure that is custom configured for an event or venue. The data structure is then modified with newly-acquired audio, video, and/or data collected from an event or venue and the final structure is recorded on a portable recording medium, such as a DVD disc, CD disc, or removable flash memory card. The newly-acquired multimedia content can be inserted inside either the menu portion or the movie portion of the DVD. By using pre-authored DVD template and replacing an existing DVD chapter or DVD title, substantial time is saved in cutting the final formatted portable recording medium. The invention provides the advantages of quickly generating personalized DVDs within minutes of the actual video/audio/data acquisition.

The invention prepares real-time audio and video contents for recording in DVD compatible format and inserting the contents inside an existing DVD template as a post-processing production step. The DVD-compliant template is considered as an input of the DVD process and is created with a DVD authoring tool. The title or chapter to be inserted is encoded and configured to be DVD compliant.

According to the present invention, a DVD may be generated for a venue or project that relies on a common set of pre-recorded menus, movies, and pictures. In the final cut of the DVD, unique video, audio, and data files from an external source are different between each personalized DVD. Since much of the DVD content is common between each personalized DVD, the lengthy portion of the authorizing process for each DVD is contained inside the DVD template. Re-use of all common elements contained in the DVD template removes much of the inefficiency of current DVD authoring methods. This process provides for efficient and rapid production of personalized DVD discs.

### BRIEF DESCRIPTION OF THE DRAWINGS

For a better understanding of the nature of the present invention, its features and advantages, the subsequent detailed description is presented in connection with accompanying drawings in which:

FIG. 1 is a schematic diagram of a multimedia optical disc generation system for generating a DVD template folder of the preferred embodiment;

FIG. 2 is a schematic diagram of a multimedia optical disc generation system for capturing new video clips and generating a personalized multimedia optical disc of the preferred embodiment of the invention;

FIG. 3 is a flowchart of a process of the preferred embodiment used to create a personalized DVD disc in the system of FIG. 2;

FIG. 4 is a flowchart of a process used to create a DVD template folder;

FIG. 5 is a schematic diagram of data structure used in the preferred embodiment of a personalized DVD disc;

FIG. 6 is a schematic diagram of data packet structure for a personalized DVD disc;

FIG. 7 is a flowchart of a process to acquire audio/video files in the system of

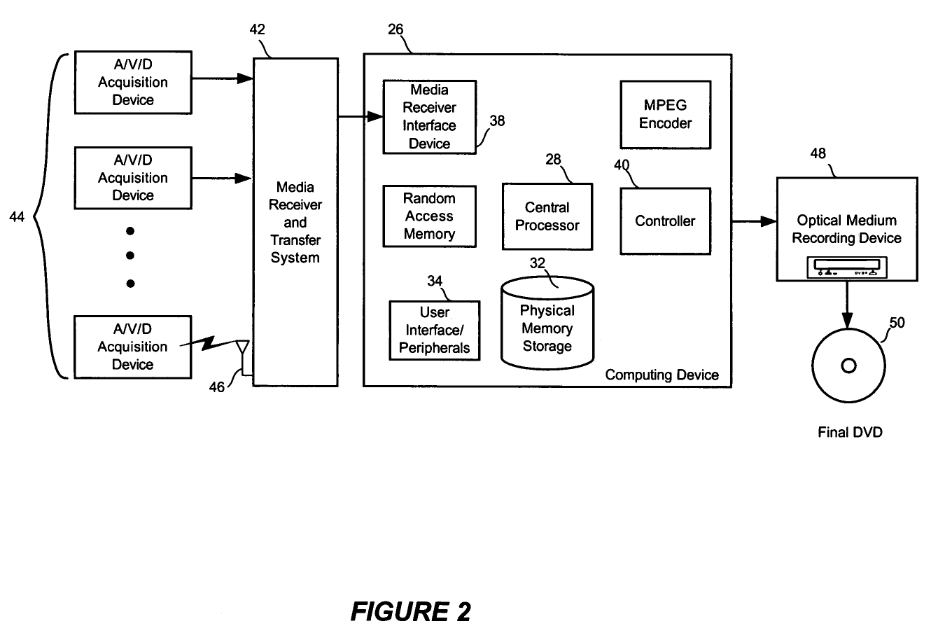

FIG. 2 and encode the files in an MPEG encoder;

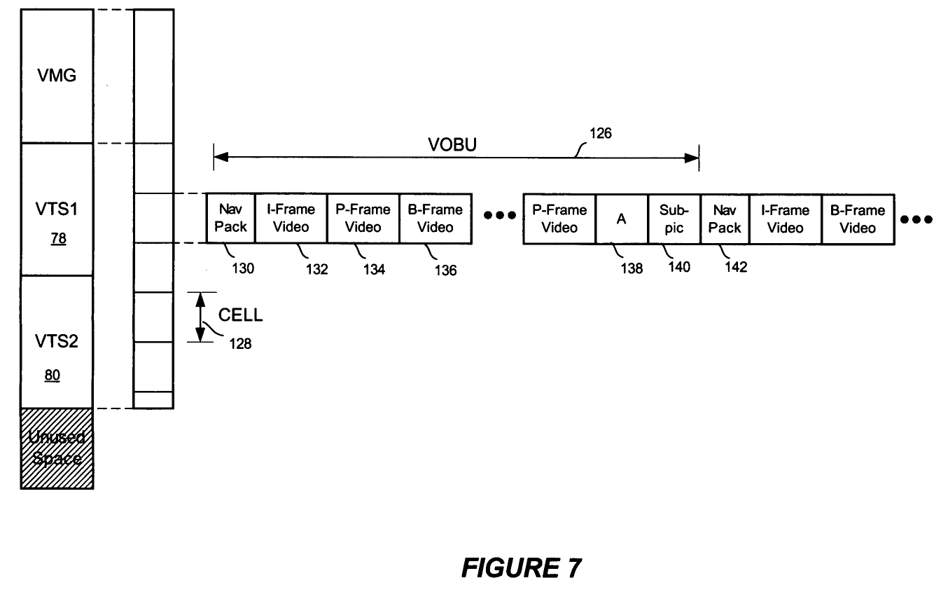

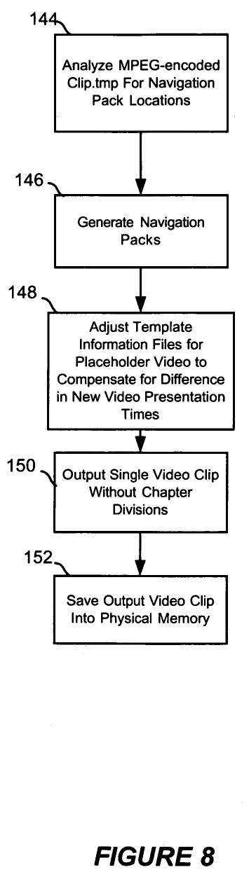

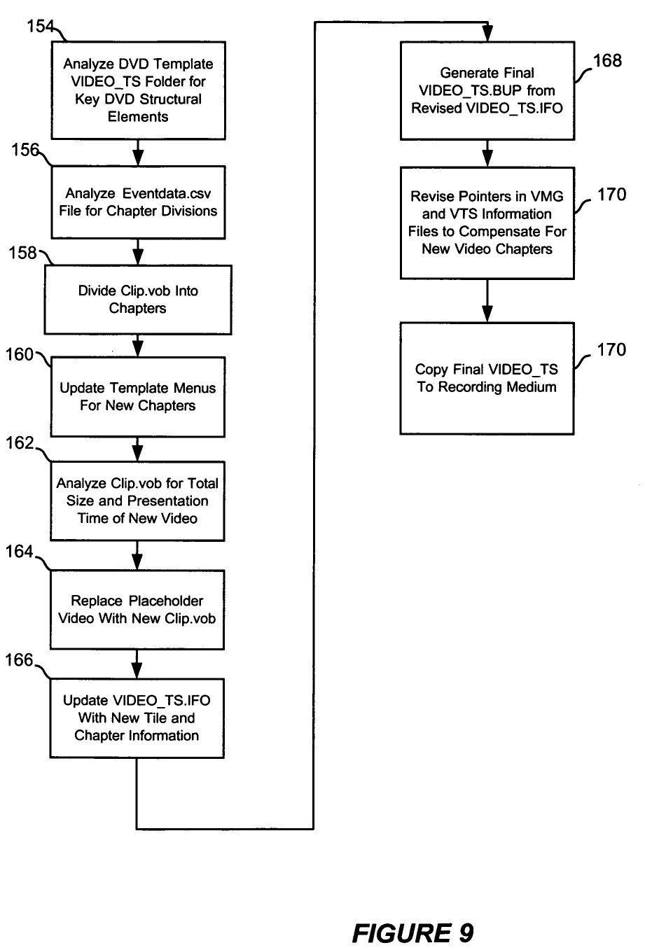

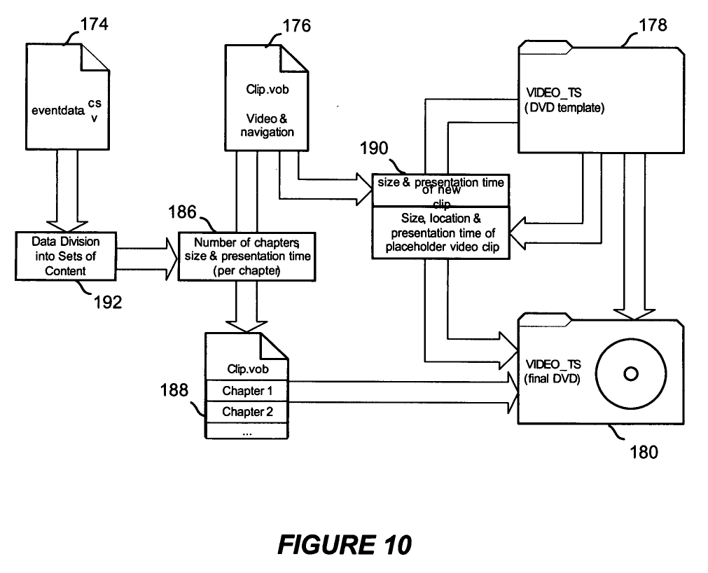

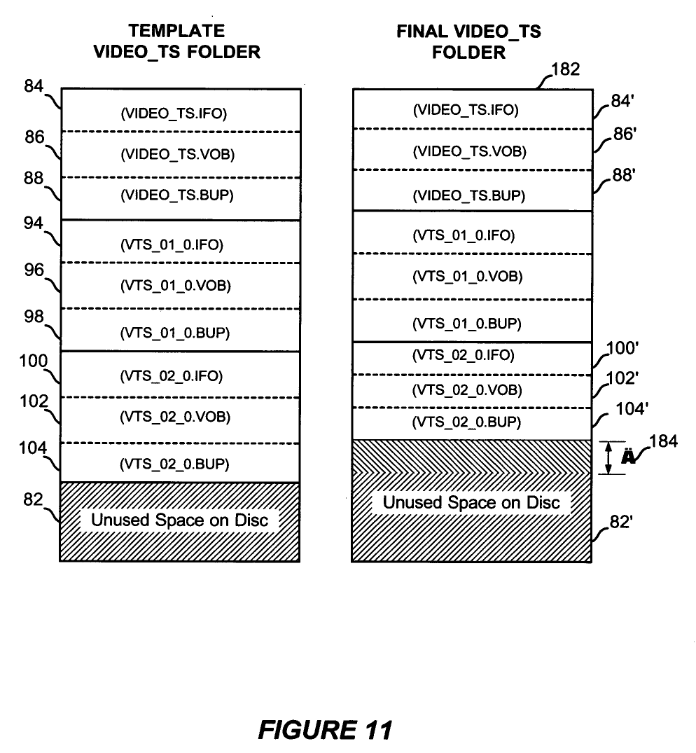

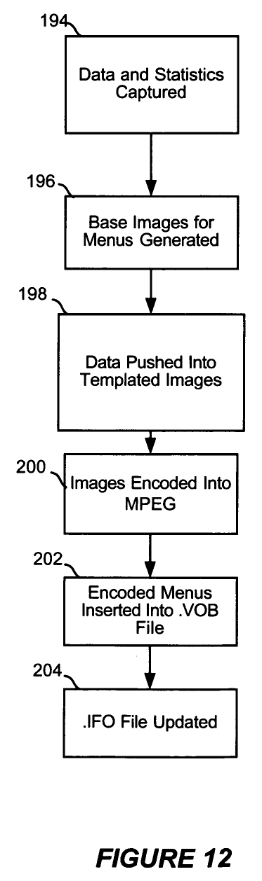

FIG. 8 is a flowchart of a process to add navigation pointers to the encoded MPEG file generated in FIG. 7;

FIG. 9 is a flowchart of a process to revise a DVD template folder to generate a personalized DVD disc;

FIG. 10 is a functional flowchart of the process flowchart to revise a DVD template folder to generate a personalized DVD disc in FIG. 9;

FIG. 11 is a block diagram of data structure of a template DVD VIDEO_TS folder and a final DVD VIDEO_TS folder;

FIG. 12 is a flowchart of an alternative embodiment for generating a menu page of data.

### DETAILED DESCRIPTION OF THE INVENTION

Exemplary embodiments of the present invention include a process and system for generating a template folder that is formatted according to Digital Versatile Disk (DVD) standards and recording a final revised template folder onto a multimedia optical disc, such as a DVD disc. A system that generates a personalized DVD merges new audio, video, and data content into a file structure of the DVD template folder and generates a formatted optical multimedia disc using a DVD recording device that is ready for playback on a typical DVD player.

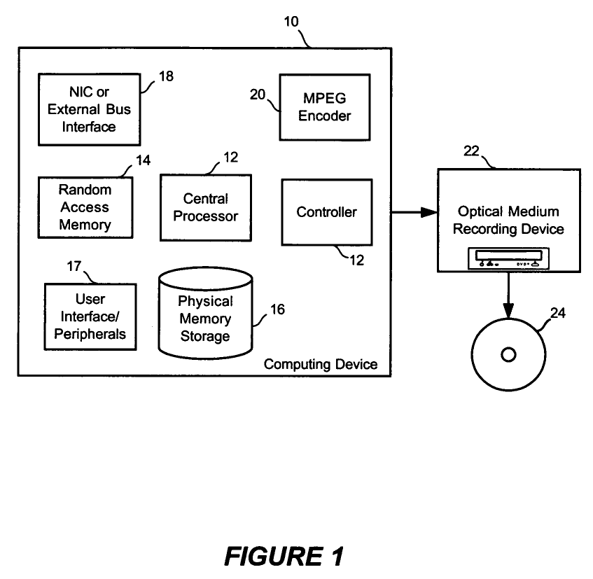

Referring to FIG. 1, a schematic drawing illustrates a computing and recording system for creating a DVD template folder that can later be modified and revised with event- or venue-specific video recordings and corresponding data. A computing device 10 is a stand-alone or networked computer that may include processors, soft memory, hard memory storage, and appropriate external peripherals 17 for user input and control of the system and input from external data sources as is known in the art. In the computing device 10, a central processor 12 is operably connected to random access memory 14 and physical memory storage 16 such as a hard drive or flash memory on a chip. A network interface card (NIC), serial bus, or parallel bus 18 or equivalent device provides an interface for transmitting and receiving digital signals and formatted data files. Operably attached to processor 12 is a hardware encoder 20 for encoding audio, video (“A/V”), and data files into a format suitable for copying to an optical multimedia disk, such as the encoded format standardized by the Motion Picture Experts Group (MPEG). Operably connected to the computing device 10 is an optical medium recording device 22 for saving formatted files from the computing device 10 onto an optical multimedia disc 24 such as a DVD. Computing device 10 has a separate or functional controller 19 of functions and processes used in the generation of DVD template files and recording the files to the DVD disc.

FIG. 2 is a schematic diagram of a computer system that is used for authoring and generation of a final personalized DVD disc according to the preferred embodiment. In the preferred embodiment, the system could be the system of FIG. 1 with additional components or is a separate system located at or near a particular venue or event. Computing device 26 is a stand-alone or networked computer that may have processors, soft memory, hard memory storage, and appropriate external peripherals (not shown) for user input and control of the system and input from external data sources as is known in the art. In the computing device 26, a central processor 28 is operably connected to random access memory 30 and physical memory medium 32. Physical memory medium 32 includes any kind of re-writable computer-readable memory such as re-writable compact discs (CD-R), DVD-R discs, floppy disks, magnetic tape, conventional hard disks, flash ROMS, nonvolatile ROM, and RAM.

Operably attached to processor 28 is a hardware encoder for encoding audio, video, and data streamed directly to the encoder or files saved in physical memory 32 into an MPEG format suitable for copying to an optical multimedia disk 50 using standardized DVD format. Operably connected to the computing device is an optical medium recording device 48 for recording (e.g., “cutting”) formatted video files and data structure from the computing device onto an optical multimedia disc 50 such as a DVD. Computing device 26 has either a controller 40 of functions and processes used in the generation of a final cut of a DVD disc 50 or processor 28, RAM 30, and physical memory 32 executes authoring software to act as a functional controller 40.

Computing device 26 either functionally contains, or is directly or wirelessly connected to through a media receiver interface 38, a processing station 42. Processing station 42 is a multimedia processing and transfer system that receives, processes, and transfers audio, video, and data streams from one or more external A/V/D acquisition devices 44 (acquisition device). Acquisition device 44 contains one or more audio, video, and/or data recorders that capture images, sound, and data from various types of capturing and recording devices as is known in the art, such as cameras, microphones, biometric sensors, geospatial and speed detectors, system operation meters, environmental sensors and detectors, etc.

Processing system 42 receives A/V/D files transferred from acquisition device 44. If processing system 42 is separate from computing device 26, then received data from acquisition device 44 is temporarily stored or buffered prior to transfer to computing device 26. A/V/D transfer may be accomplished through a wireless connection 46, or wired connection, or portable storage as is known in the art between processing station 42 acquisition device 44. If more than one file is generated from acquisition device 44, processing station or controller 40 analyze the received A/V/D files to ensure the particular time of A/V/D generation in acquisition device 44 in each different file is synchronized to one another for simultaneous playback and/or graphical display. An exemplary method to provide synchronization of different generated A/V and data files are to add a common time code signal from a common external or internal system clock.

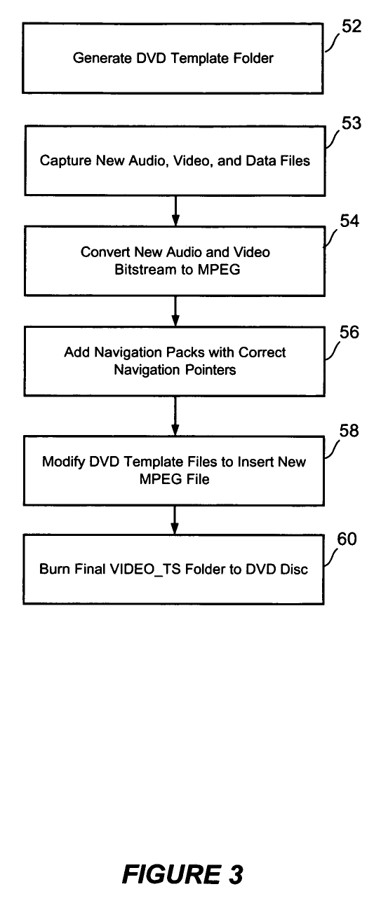

FIG. 3 is a flowchart showing the general steps of the preferred embodiment for generation of a personalized DVD that can be performed in the system of FIG. 2. Each step in the process is further described in greater detail in the subsequent Figures and corresponding description. The first step described in flowchart box 52 is the creation of the DVD template folder. The template DVD folder includes the incorporation of a First-play video clip and a placeholder video clip in a VIDEO_TS folder. This initial process to a DVD template folder may optionally be performed on the exemplary system illustrated in FIG. 1. The second step in box 54 is acquisition of new A/V and data files in real-time from external acquisition devices 44 and encoding the A/V files using the hard encoder 36 into a multimedia format compliant for playback on an optical disc, such as MPEG format requirements. The result of this step 54 is one or more generated files forming a valid MPEG system stream, such as MPEG-2. However, in this step 54 the MPEG file is not fully compliant with modern DVD standards. The third step 56 in the preferred process includes modifying the encoded file(s) created in step 54 to include additional formatting of the system stream for compliance with DVD standards. Modification includes inserting navigation packs into an MPEG bitstream. This process is explained in more detail below. In the fourth step 58, the new MPEG system stream(s) and data acquired from processing station 42 are analyzed and formatted to merge into the final DVD template VIDEO_TS folder. In the final step 60, files and data on the final VIDEO_TS folder are recorded onto a computer-readable medium. In the preferred embodiment, a computer-readable medium includes a multimedia optical disc generated using the recording device 48 that outputs a final DVD disc 50 ready for playback. Other computer-readable mediums include any kind of computer-readable memory such as compact discs having read-only memory (CD-ROMS), re-writable compact discs (CD-R), floppy disks, conventional hard disks, flash ROMS, nonvolatile ROM, and RAM.

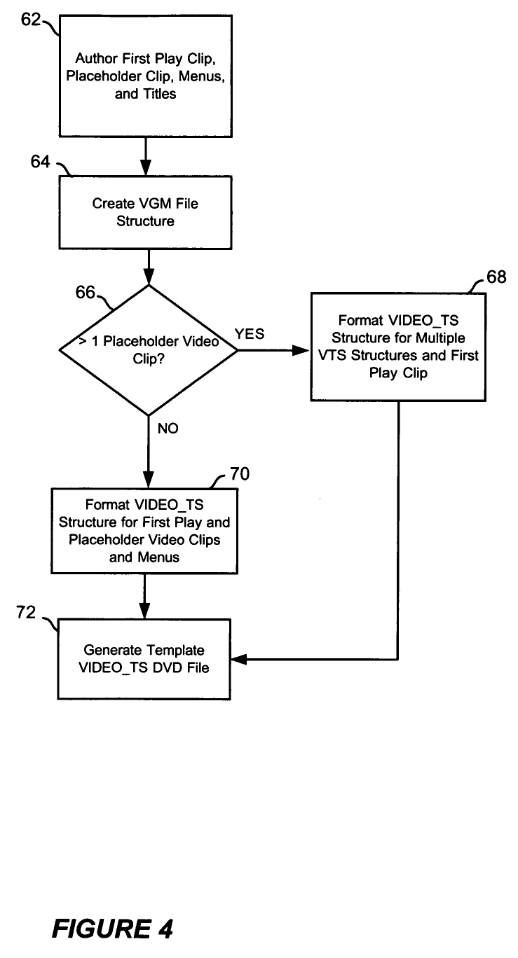

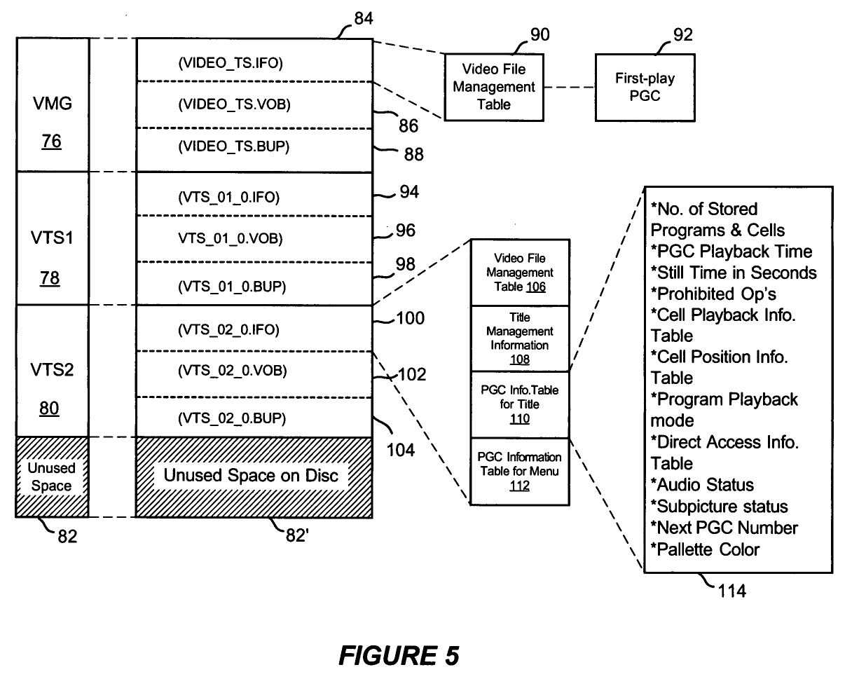

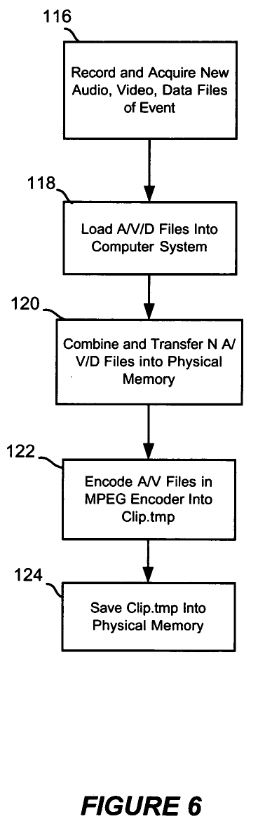

The process of the preferred embodiment for creating a DVD template file 55 is described in relation to the flowchart of FIG. 4 and data architecture diagrams of FIGS. 5-6. The DVD template is a folder that contains all the DVD files required for a DVD player to display a sample DVD presentation with menus and at least one place-holder video clip.

In the first step 62, one or more pre-authored and recorded audio and video (A/V) files and associated data files are authored and assembled in computing device 10. The A/V stream(s) is encoded via an MPEG encoder 20 in either hardware or software and saved to physical memory 16. The A/V stream(s) may include a First-play video clip that is meant for playback automatically prior to the start of a chapter video. Another video clip in the stream is a placeholder video clip which will be used as a dummy clip to setup proper menu and title structures in the template and eventually replaced by a newly-acquired video clip.

An exemplary DVD template folder is authored with a DVD-compatible data structure 64 named VIDEO_TS having Video Manager (VMG) structure 76 and multiple Video Title Sets (VTS) structures named VTS1 (78) and VTS2 (80). In the VIDEO_TS folder 64 of FIG. 5, only two video title sets VTS1 and VTS2 are shown as the optional First-play video title set and the placeholder video title set. These VTS positions are merely exemplary for the purposes of illustration. Fixed or pre-authored clips in the template could use multiple title sets each and could be located at any VTS location available within the data structure of the DVD. For example, some currently-available DVD-compatible discs may have up to 99 video title sets.

The remaining space on a disc formatted according to the block diagram in FIG. 5 is labeled as “Unused space” 82 and 82′. VMG 76 content includes a file named VIDEO_TS.IFO (Video Title Set Information) 84, which includes data structure and location information for playback of all video title sets on the disc. The VIDEO_TS.IFO 84 is also called the Video Manager Information (VMGI) file. The VMG 76 also contains a duplicate backup file of VIDEO_TS.IFO that is named VIDEO_TS.BUP 88. The backup .BUP file 88 is a required file for DVD-compliant discs and can be used for playback if the original .IFO file 84 becomes corrupted or unreadable. VMG 76 may also include an optional video object file named VIDEO_TS.VOB 86, which contains the contents for a title menu. The title menu allows a user to access video titles that are contained in other title sets and may contain short clips of notices to users.

The VIDEO_TS.IFO folder 84 must contain a data structure named VMGM_MAT 90. This data structure has template information that includes the disc sector locations of the VMG 76, VMG category and regional codes, DVD Specifications version, the number of video title sets, and starting sectors of other files used for DVD playback. The VMGM_MAT 90 also includes a data structure named First-Play Program Chain (PGC) 92. The fields of this data structure relate to the contents and location of the First-Play PGC video clip. The First-Play PGC 92 does not contain any programs for playback but instead executes commands for automatic playback of the first video clip existing in the VMG, a title, or a root menu of another Video Title Set.

In addition to the VMG 76, the VIDEO_TS folder must contain at least one video title set. As stated previously, in FIG. 5 two exemplary Video Title Sets, VTS1 and VTS2 are illustrated. Each VTS includes three files, each generically called VTS_xx_{—}0.IFO, VTS_xxy.VOB, and VTS_xx_{—}0.BUP (a backup of the VTS_xx_{—}0.IFO file). VTS1 (78) contains the video title set information file called VTS_{—}01_{—}0.IFO 94. This file is required by each title set and retains details of the VTS such as exactly how many titles, the number of chapters, and the data structure and times stamps for the VTS. It also include video file encoding information (e.g., MPEG-2 compliant), sub-picture stream for the VTS, and the exact sector and byte location of the starting and ending points of the video in the VTS on the disc. The file VTS_{—}01_{—}0.BUP 98 is created in VTS1 as a backup file to VTS_{—}02_{—}0.IFO 94. In FIG. 5, VTS2 (80) has the three Video Title Set files with extensions IFO 100, VOB 102, and .BUP 104 with a similar structure and purpose as the corresponding files in VTS1 (78). However, these files are specifically created to hold information for a separate video clip in VTS2 (80).

In addition to menus and pictures, the personalized DVD template may include a pre-recorded “First-play,” or introductory, video clip that is encoded and saved into VTS1 (78) as the first video clip to play on a disc. For example, the First-play PGC menu 92 has pointers to the First-play video clip in VTS_{—}01_{—}1.VOB 94. The command of jump to title 1 (JumpTT 1) in the First-Play PGC 92 would begin the playback of the sample video clip in VTS1 (78) during playback of the final DVD.

The personalized DVD template of the preferred embodiment also contains at least one dummy placeholder video clip. This placeholder clip is provided in the form of video title set, title, and chapter numbers. In the preferred embodiment, the placeholder clip is located in VTS_{—}02_{—}1.VOB 100 in VTS2 (80). In a final generation of the DVD, placeholder file is removed and replaced by one or more new encoded video clips acquired in real-time from acquisition device 44 at particular venue or event. If more than one placeholder video clip is required 66, then the VMG 76 is authored to provide a structure for multiple title sets along with the optional First-play clip 68. If a single placeholder clip is required 66, then the VMG 76 is authored to hold only a First-play clip in VTS1 (78) and a single placeholder video clip in VTS2 (80).

The final step to creating a personalized DVD template is creating a DVD-compliant VIDEO_TS folder structure that contains all the titles, menus, and data required that can be modified at a later time with a final encoded video clip and associated titles and data. Some of the template structure generated for the placeholder video is shown in FIG. 5 associated with the VTS1 folder 100 of VTS2 (80). Structured information data for VTS_{—}02_{—}0.IFO includes a video file management table 106, a title management information table 108, a PGC information table for the title 110, and a PGC Information table for the menu 112. The table for the PGC information for title 110 contains data information 114 for the title such as the number of stored programs and cells (explained below), PGC playback time, still time, prohibited operations, cell playback information and position, program playback mode, direct access information, audio and subpicture status, PGC numbers, and palette colors.

The flowchart in FIG. 6 illustrates detailed processes of the second step 54 in the generation of a personalized DVD. In box 116, one or more new audio, video, and/or data files are recorded in A/V/D acquisition devices 44, as previously described, of an event, ride, activity, etc. at a venue. The files are all loaded 118 into computer device 26 and appropriately combined together 120 and synchronized into physical memory storage 32. The processed audio and video files are then encoded through the hard encoder 36 and exported in a MPEG-encoded format in a file named clip.tmp 122. This encoded file consists of packetized bytes of MPEG-2 data called system packs.

Referring to FIG. 7, a snapshot of a bitstream of MPEG-encoded data for the video title sets is represented in the exploded block diagrams. The packetized data in FIG. 7 represents data from video title sets VTS1 (78) or VTS2 (80). In summary, at the highest level of DVD data structure, a video title represents one or more linked Program Chains (PGCs). A PGC may have up to 255 programs. The programs are organized sets of pointers to one or more cells. A Part-of-Title (PTT) is a sequence of one or more programs with consecutive numbers within a PGC. PTTs are commonly referred to as chapters. A PGC has pointers to subsequent, previous, or hierarchical PGC. PGC functions provide the number of programs and cells, the playback time, a program map, prohibited operations, subpicture stream status, still time, playback mode, palette colors, and cell command table, playback information and positioning information.

The minimum video unit in the structure is the Video Object Unit (VOBU) 126. Each VOBU consists of a navigation pack and packetized, multiplexed audio and video streams with optional sub-pictures. Navigation packs are located at the beginning of every VOBU and are used to identify the location of the associated frames in the cell. One or more VOBUs are required to form a cell 128. Each cell 128 contains a unique identification number that is placed in order for playback by the PGC Information Table.

In forming each pack of data, the MPEG encoder buffers audio and video streams, compresses the streams, and performs synchronization using timestamps in both media streams. The new audio stream entering the MPEG encoder is encoded by either linear pulse code modulation (PCM), Dolby Digital, or MPEG Audio methods. The new video stream entering the encoder is a series of MPEG picture frames. Typically, the majority of the images in each frame do not change significantly between adjacent frames. MPEG standards specify an inter-picture coding that can describe certain types of MPEG picture frames in relation to a reference frame. The standard calls for three kinds of MPEG pictures: 1) intra (also called I-picture or I-frame), 2) predicted (also called P-picture or P-frame), and 3) bidirectional (also called B-picture or B-frame).

In FIG. 7, an exemplary VOBU 126 with a navigation pack 130, I-frame 132, P-frame 134, B-frame 136, audio frame 138, and sub-picture frame 140 is shown. The I-frames 132 are original digital pictures, such as a JPEG formatted picture, and use transform encoding from the original picture itself. Encoding for P-frames 134 uses the nearest I- or P-picture to create a forward prediction of what the P-frame will look like. P-frame pictures provide greater compression than I-frames but a tradeoff occurs due to the greater probability for coding errors in P-frames. B-frames 136 use bidirectional encoding of pictures in an MPEG video stream. Unlike the P-frame that only uses the nearest prior P- or I-frame in coding, the B-frame 136 uses both a prior and a subsequent picture as a reference. A subsequent VOBU begins at the next navigation pack 142.

In step 124, the A/V clip clip.tmp is generated from encoder 36, it is saved into physical memory 32 for further processing.

FIG. 8 is a flowchart that illustrates details of the next step 56 in the generation of a personalized DVD using a DVD template folder. Here, the preferred process analyzes all of the MPEG system stream file clip.tmp 144. The MPEG encoder is configured to identify the location and System Clock Reference (SCR) of all I-, B-, P-, and audio-frames. Knowledge of these elements provides information required to generate and insert in real-time DVD-compliant MPEG navigation packs into the packetized system stream. A navigation pack and associated packetized picture frames are the minimum definition of a “cell” of MPEG bitstream. A video object unit (VOBU) is comprised of one or more cells in the bitstream. Thus, a navigation pack is generated 146 and inserted immediately before each I-frame, which then becomes the first pack of each cell. The result of the real-time step is converting the clip.tmp file to a file called, for example clip.vob, that is a valid MPEG system stream that is similar to a compliant .VOB file. However, in this step of the process the navigation packs are not yet fully DVD-compliant.

After analysis of the navigation packs, the process updates navigation pointers 146 that were added to the encoded MPEG-2 packetized system stream in previous step 54. Updating the navigation pointers 146 is required to adjust the presentation time 148 identified in the navigation packs. Similarly, the remaining DVD files (.IFO and .BUP) are adjusted to compensate for the difference in presentation time between the original title/chapter of the placeholder video and the newly acquired video clip. At this stage in the process, the video clip is considered as a single large title with no chapters 150. The single updated file is saved 152 into physical memory 32 for further processing.

FIGS. 9-11 illustrate the detailed processes of step 58 of the personalized DVD generation process. The graphical flowchart in FIG. 10 summarizes the process of the preferred embodiment for the generation of the final DVD VIDEO_TS folder 180 from the template DVD VIDEO_TS folder 178. Here, the template folder 178 is modified with new video clip file clip.vob 176 and associated navigation information that replaces the placeholder video clip in the template VIDEO_TS folder 178. This method of replacing the placeholder video clip in the template folder can be modified to replace other clips and menu pages as well. For example, menu pages, First-Play video clips, previews, advertisements, or notice pages may be inserted as a placeholder item in the VIDEO_TS template folder and replaced with final versions of each respective item in the final formatted VIDEO_TS folder.

The single file clip.vob 176 is divided into chapters 188 by using the eventdata.csv data file 174 to determine occurrences in the event or venue based upon pre-programmed divisions or points of the data 192. The divisions or points of occurrences in the data determine the number of chapters, chapter size, and presentation time per chapter 186. The size and presentation time 190 of the new video clip is used to modify the VMG and VTS files associated with the placeholder video 190 in the template folder 178 for the final VIDEO_TS DVD folder 180 that are now associated with the new video clip.

Referring additionally to the functional flowchart in FIG. 9 and the block diagram in FIG. 11, the preferred generation of a final DVD disc 50 from the DVD template folder begins with the step described in box 154 of analyzing the DVD template folder VIDEO_TS 178 for key DVD structural elements such as the elements described in FIGS. 5 and 7. In step 156 the data file eventdata.csv 174 is analyzed 174 to determine chapter divisions for the new video clip in clip.vob 176. This data file contains new event- and venue-specific independent data collected at a particular site that is time-synchronized to the new video clip. If the new video file contains repetitive or divisible events that are data-monitored, then the eventdata.csv file is analyzed 156 to determine possible chapter divisions in the video clip based on the data from the repetitive or divisible events. In step 158, the video clip is actually divided into chapters and each chapter's exact location in the video clip is used to modify the structure files in template VIDEO_TS 178. For example, if the video clip contains a recording from a sports event, a synchronized data file that recorded of the beginning and ending of quarters, innings, sets, laps, etc. may be analyzed to create a division of the clip into chapters for each of the timed divisions in the sports event. Further, if a person participates in an event, ride, or game then the video clip could be divided into chapters according to each participant's repeated performance or change in involvement. In a scenario having a repetitious event that is performed by multiple participants, the chapter divisions could occur at common points in the event regardless of the performance of individual participants.

Telemetry data could be collected from acquisition devices 44 of different aspects of each event and each participant and transmitted in real-time or upon completion of the event to the processing station 42 in order to be integrated into the final DVD disc of the event. Data includes video from cameras, audio from microphones, timing of the entire event in a common clock, biometric data from participants, venue-specific and geographical data, environmental data, etc.

Some specific, non-limiting examples of data collected at an event according to the preferred embodiment are if a video recording is created of a little-league baseball game, each chapter could correspond to each inning in the game. Another event scenario is a video recording of a rider of a theme park or equivalent ride, where different areas or activities of the ride are divided into different chapters. At an event featuring a vehicle driving on a road or track, video clips of the car and driver and associated data for driving and track conditions could be collected contemporaneously. Video of the start and end of the road or laps of a vehicle around a track could be divided into different chapters.

In the next step 162, the new MPEG-2 encoded file, containing clip.vob, is analyzed to determine the total size and presentation time of the entire new video. The file contains the chapter divisions of the filmed event, gained from the processing of the chapter divisions from the eventdata.csv 174 file. The clip.vob 176 file is copied directly to the template VIDEO_TS folder and replaces the placeholder 164 clip in VTS2. The DVD template data structure for the size, the location, and the presentation time of the placeholder video are modified with the data regarding size, location, and presentation time of the new video clip. Further, the DVD template structure elements in VIDEO_TS.IFO and VTS1 folders in chapters that identify titles and chapters, their duration and locations, and all information related to navigation for files on the DVD are all updated appropriately for the new video clip that replaced the placeholder clip.

Referring to the illustration in FIG. 11, the files and structural data divisions of the template VIDEO_TS folder are shown on the left box diagram and the corresponding files and divisions of the format for the final VIDEO_TS folder are shown in the right box diagram. Part of the preferred step 166 for updating the template VIDEO_TS.IFO file 84 to generate the final VIDEO_TS.IFO file is to modify the file for the new location, size, and duration of the video title set that contains the new encoded MPEG video clip as well as to identify the location and number of chapters in the new clip's title. Next, the template VIDEO_TS.VOB 86 is copied without modification into the final VIDEO_TS folder. The final VIDEO_TS.BUP backup file is generated by copying over the content of the final version of the VIDEO_TS.IFO file.

In the final version of the first new video title set in block 182, the VTS_xx_{—}0.IFO file, corresponding to the updated video title set, is modified to reflect the information about the new video clip. In the preferred embodiment, this file is named VTS_{—}02_{—}0.IFO 100 and holds the information for the new video file created from new event file clip.vob. To insert the new video clip, multiple placeholders of the destination VTS are modified. The number of chapters, location of chapters, and all other video title set information are updated as required by the new event video clip. The old placeholder video clip located inside VTS_xx_y.VOB (e.g., VTS_{—}02_.VOB 102) file is replaced by the content of the new clip.vob. Using the number, size, and presentation time of the new chapters, the navigation packs of each packetized data sets are updated to identify the newly inserted DVD chapters. A final analysis of the VTS_xx_y.VOB file is performed to adjust the start and stop presentation time throughout the VOB file. The VTS_xx_{—}0.BUP backup file (e.g., VTS_{—}02_{—}0.BUP 104) is then generated by copying over the content of the VTS_xx_{—}0.IFO file.

As an alternative embodiment, additional title sets may be created by the generating multiple video clips and downloading these clips into the processing system 46 for encoding through the MPEG encoder 36. The respective VTS files named generically VTS_xx_{—}0.IFO, VTS_xx_y.VOB, and VTS_xx_{—}0.BUP would increase in file identification number starting at “03” for the “xx” for any additional title sets. These files of additional event clip video recordings are copied over to the final VTS unmodified without having to replace additional placeholder files.

FIG. 12 contains a process flowchart of an alternative embodiment of the present invention that provides generation and insertion of menu pages that contain data associated with the event. Data and statistics related to the video capture of an event are captured 194 by acquisition devices 44 and, in addition to determining breaks or chapters of the final video clip in step 156 using the event data 174, the data can be displayed graphically in menu pages generated for the final DVD VIDEO_TS folder 180. If desired, multiple pages of data and/or statistics corresponding to the events captured in the new video clip could be generated as menu pages and inserted into the VIDEO_TS.VOB file 176.

The process of creating menu pages in which data are displayed on the DVD is independent of the process of the preferred embodiment for creating the final DVD VIDEO_TS folder 180. The menu of a DVD is an encoded MPEG movie file that contains subtitles. A menu contains graphics, buttons, and links to other menus or to titles. The base image, or background, in a menu can be either a very short video such as a single frame of video or a still image that has been encoded and converted to an MPEG file. Basic subtitle images are used in the menu to show buttons in a normal or “quiet” state, a highlighted image show buttons changed under a cursor, or the subtitle image could show a button in a selected state after clicking the button with a mouse or selecting with a remote control device to a DVD player.

To create data summary pages, base images for menus are generated in step 196 and placed into the DVD template folder 178. After a set of data is gathered 194 from each venue event and assembled for publishing, the data is pushed into one or more templated base images 198. The images, containing the published data, are then encoded into MPEG format in step 200 by MPEG encoder 36. In step 202, the encoded menus are then inserted into the VIDEO_TS.VOB file. After the data pages are inserted into the VIDEO_TS.VOB file, the data structure in the information VIDEO_TS.IFO file is updated in step 204 so the buttons and commands are added to the title set. The steps provide for the generation and graphical playback of the data files (e.g., telemetry files) that were generated together with the original video files from a venue event. The final update to the VTS receiving the data pages is copying the VTS information file over to the VTS backup file in step 190.

Since the addition of menu pages is an independent and optional feature of the preferred embodiment, the data menu pages may be generated simultaneous to the generation of the final VIDEO_TS folder in FIGS. 9-10 or completed before or after that process.

In the generation of the final VIDEO_TS folder 182 from the template version, the duration and size of the new event video clip will most likely vary in length and physical size on the DVD disc from the placeholder video. In the hatched areas of the block diagrams in FIG. 11, the “Unused” areas 82, 82′ are not the same exact size with one other and the size of the “VTS2” files in blocks 100′-104′ of the final folder 182 are not the same size as the corresponding VTS2 template files in blocks 100-104. Likewise, the size of files in the video manager will typically change between the template VIDEO_TS folder and the final VIDEO_TS folder. The files VIDEO_TS.IFO 84, VIDEO_TS.VOB 86, AND VIDEO_TS.BUP will change to corresponding files with the same name shown as blocks 84′, 86′, and 88′, respectively. If the final version of the revised VGM and VTS2 files are the exact size of the corresponding templated files, then no compensation in the final VIDEO_TS folder is necessary. However, if the final versions for VGM and VTS2 are smaller (as shown in FIG. 11) or larger, then this difference in size that is shown as delta 184. Thus, the change in file sizes must be compensated for 170 in the final VIDEO_TS folder. To perform compensation, the pointers in the video manager and video title set information files for the entire title set and for the individual information file in VTS2 must be modified. For VTS2, these are modified to reflect exactly where the new event video title chapters begin and end. In the preferred embodiment, the beginning of both the placeholder VTS2 and the new VTS2 will begin at the same location, which is after the end of the First-play video clip in VTS1 94-98, which remains unchanged. Therefore, only the pointers for the chapter or chapters in new VTS2 that are either smaller or larger than the chapters in the placeholder video title set are changed. After the pointers in the video manager and video title set files are updated, the modified, final VIDEO_TS folder is ready for copying to a recording medium 172, such as a DVD disc.

An output of the method and system of the preferred embodiment is the final VIDEO_TS folder that is ready to be burned onto a recordable optical multimedia disk, such as a DVD that can by played by common commercially available DVD players. By updating the VIDEO_TS template file with the preferred embodiment, a personalized DVD may be cut by burning the final version of the VIDEO_TS folder to the optical medium.

If the system to cut the final DVD is located on-site of a particular venue, whether the venue is a theme park with rides or shows, entertainment or sporting event, a commercial, retail, or research venue, a user can choose to create a personalized DVD that includes motion picture video chapters and summary data pages from the event or from the user's personal experience in the event. For example, a person may attend a theme park, concert, sporting event, entertainment, research project, medical procedure, or other event where a person can personally participate in the event. Video, audio, and data from the user's personal experience and operational or other data from the devices, rides, locations, vehicles, results, and environment may be collected and saved at or near the event location. A DVD template is prepared with First-play and placeholder videos, menus, and titles for the particular event that can then be modified with the real-time collection of A/V/D that is relevant to the event or a group's or participant's personal experience in the event. When all the prior steps are completed to create a final VIDEO_TS folder for the event and the personalized video clips and data have been chosen for saving to a disc, then a final VIDEO_TS is burned 60 to a multimedia optical disc, such as the DVD disc 50.

One skilled in the art will appreciate that the present invention can be practiced by other than the described embodiments, which are presented for purposes of illustration and not limitation, and the present invention is limited only by the claims that follow.

What is claimed is:

1. A method for providing a data structure containing multimedia content, comprising:
authoring a management section for managing said data structure, which includes a menu information section and a title information section for multimedia data;
authoring a title section comprising a first packetized video file and menu information for said first packetized video file;
generating a second packetized video file from a video recording of a live event; and
replacing said first video file with said second video file in said title section.

2. The method according to claim 1, further comprising:
dividing said second packetized video file into sets of content based on said live event.

3. The method according to claim 1, further comprising:
dividing said second packetized video file into chapters based on data related to said live event.

4. The method according to claim 3, wherein said dividing further comprises:
synchronizing said data with said second video file from said live event.

5. The method according to claim 1, further comprising:
adjusting said title section menu information for a difference in size of said second video file as compared to said first video file.

6. The method according to claim 1, further comprising:
adjusting said management section menu information section and said title section menu information for one of a presentation time, location, and size of said second video file that is different from said first video file.

7. The method according to claim 1, further comprising:
encoding said second video file according to Motion Picture Experts Group (MPEG) encoding specifications; and
generating MPEG navigation data in said encoded second video file.

8. The method according to claim 1, further comprising:
after performing the steps of claim 1, recording said management section and said title section onto a multimedia recording medium.

9. The method according to claim 1, further comprising:
performing the steps of claim 1 according to applicable DVD standards; and
generating a DVD-compliant optical medium containing said management section and said title section.

10. The method according to claim 1, further comprising:
capturing data from said live event;
copying said captured data into an image file for publication;
providing a menu page by encoding said image file in an MPEG encoder;
inserting said menu page into said title section; and
adjusting said management menu information section to account for said menu page.

11. The method according to claim 1, further comprising:
authoring a first advertisement page for said title section;
generating a second advertisement page related to a venue of said live event; and
replacing said first advertisement page with said second advertisement page.

12. A system for producing a multimedia recording medium, comprising:
an acquisition device for recording audio and video from an event;
a computing device, operably connected to said acquisition device and said data acquisition device, comprising a processor and a data recording medium for processing and saving one or more streams of audio and video recordings received from said acquisition device;
wherein said data recording medium contains a management section for managing a data structure, which includes a menu information section and a title information section for multimedia data, and a title section comprising a first packetized video file and menu information for said first packetized video recording,
wherein said processor is programmed to:
generate a second packetized video file from said audio and video recording of said live event, and replace said first video file with said second video file in said title section.

13. The system according to claim 12, further comprising:
a data acquisition device, operably connected to said computing device, for recording data associated with said event,
wherein said data recording medium receives said recorded data, and said processor is further programmed to:
divide said second packetized video file into sets of content based on said data collected from said live event.

14. The system according to claim 13, wherein said processor is further programmed to:
divide said second packetized video file into chapters based on said data.

15. The system according to claim 13, wherein said processor is programmed to:
synchronize said data with said second video file.

16. The system according to claim 12, wherein said processor is further programmed to:
adjust said title section menu information for a difference in size of said second video file as compared to said first video file.

17. The system according to claim 12, further comprising:
a data acquisition device, operably connected to said computing device, for recording data associated with said event,
wherein said processor is programmed to:
copy said captured data into an image file for publication;
provide a menu page by encoding said image file in an MPEG encoder;
insert said menu page into said title section; and
adjust said management menu information section to account for said menu page.

18. The system according to claim 12, further comprising:
a multimedia recorder, operably connected to said computing device, to generate a portable multimedia medium after processing of said management section and said title section by said processor.

19. The method according to claim 12, further comprising:
authoring a first advertisement page for said title section;
generating a second advertisement page related to a venue of said live event; and
replacing said first advertisement page with said second advertisement page.

20. An optical multimedia medium having a data structure and a content, comprising:
a management section for managing said data structure, which includes a menu information section and a title information section for multimedia data; and
a title section that is generated by:
encoding a first video file and menu information for said first video file;
generating a second packetized video file from a video recording of a live event; and
replacing said first video file with said second video file in said title section.

21. The optical multimedia medium according to claim 20, wherein said title section is further generated by dividing said second packetized video file into sets of content based on said live event.

22. The optical multimedia medium according to claim 20, wherein said title section is further generated by dividing said second packetized video file into chapters based on data related to said live event.

23. The optical multimedia medium according to claim 22, wherein said dividing comprises synchronizing said data with said second video file from said live event.

24. The optical multimedia medium according to claim 20, wherein said title section is further generated by adjusting said title section menu information for a difference in size of said second video file as compared to said first video file.

25. The optical multimedia medium according to claim 20, wherein said medium is generated as a DVD-compliant optical medium containing said management section and said title section.

26. The method according to claim 20, further comprising:
authoring a first advertisement page for said title section;
generating a second advertisement page related to a venue of said live event; and
replacing said first advertisement page with said second advertisement page.
